(19) United States
(12) Patent Application Publication
(10) Pub. No.: US 2004/0006253 A1
(43) Pub. Date: Jan. 8, 2004

(54) Heavy metal particulate (HMP) emission speciation modification process

(76) Inventor: Keith Edward Forrester, Meredith, NH (US)

Correspondence Address: Keith E. Forrester, 78 Tracy Way, Meredith, NH, 03253, US

(21) Appl. No.: 10/189,828

(22) Filed: Jul. 8, 2002

(51) Int. Cl. A62D 3/00

(52) U.S. Cl. 588/256

(57) ABSTRACT

The invention pertains to a method for reducing the leaching of heavy metals from air, water and wastewater particulate emissions. The method includes contacting the heavy metal particulate with a complexing agent which converts the molecular form of the particulate to a less soluble and less bioavailable form prior to release to the environment. This method eliminates the need to remove or treat soils and environments exposed to particulate deposition and greatly reduces the environmental and health risks associated with the deposition of heavy metal particulate in the open environment as well as at controlled discharge areas.

### BACKGROUND OF INVENTION

The health and biological risks associated with inhalation, ingestion and dermal uptake of Heavy Metal Particulates (HMP) which contain one or more toxic metals such as Cadmium, Chromium, Silver, Lead, Arsenic, Barium, Selenium, and Mercury from point source and non-point source air emissions, wastewater discharges and water pollution sources such as storm-water runoff have been a major concern of health officials, environmental engineers, biologists, regulators and communities for many years. In addition to concerns over direct acute human and biological community exposure effects, professionals have also struggled with predictions of indirect and long-term exposed receptor effects within air emission particulate deposition and sediment collection impact areas where bioaccumulation or accumulate exposure at HMP toxic levels may occur. In response to these concerns the USEPA, OSHA and numerous other federal and state agencies have promulgated and continue to develop numerous regulations for monitoring and controlling both air and water-borne particulate emissions from fixed facilities such as refuse incinerators, primary ore and secondary battery smelters, auto shredders, wire choppers, foundries, steel mills, fossil fuel power plants, refineries, and numerous other industrial and commercial point source emissions, as well as from non-point source emissions such as roofs, parking lots and highways. Regulations under the Clean Air Act (CAA), National Pollution Discharge Elimination System (NPDES), Resource Conservation and Recovery Act (RCRA) and Comprehensive Environmental Response, Compensation, and Liability Act (CERCLA—a.k.a. Superfund) and other related emission and HMP regulations are extensive, complex, and have great impact on industrial, commercial and construction operations generating and/or managing regulated contaminants including HMP.

The current Air Pollution Control (APC) and Wastewater/Water Sediment Control (WSC) methods use chemical-physical or physical means and are presumptive in design, i.e., the capture of HMP in APC and WSC by filtration, gravimetric and/or cyclonic means presumes high HMP capture rates (99 99% and higher) and consequently ignores the need for engineering collection processes with anticipation of release of fine HMP during normal operations and all HMP loading during control unit upset conditions where capture is bypassed. In many APC devices, dry lime (Ca(OH)2) or slaked quicklime slurry is used as a chemical agent to convert acid gases such as sulfur dioxide and HCL prior to physical capture devices such as baghouse filters to solid calcium salts such as CaSO4 or CaCl2, yet this same addition of lime creates oxides within particulate lead and other metals which then increases the leachabiity and bioavailability of the fine uncontrolled heavy metal particulate emissions from the air source which are not captured by the filtration capture devices. To further complicate the matter, these fine particulate releases are now also more bioavailable as they are more readily inhaled and ingested as well as have a high surface area to weight ratio than collected fines, and thus are most in need of being in a non-toxic and low leachable form.

A similar failed engineering design condition exists at water and wastewater treatment plant water discharges, where RIP fines pass through flocculation and settling reactors and secondary filters to receiving waterways and aquatic life, in a molecular form of heavy metal designed for organic and bacteria control, settling and filtration without consideration to the fines releases toxicity and bioavailablity in the receiving stream, river or water body. One major failure of wastewater treatment plant discharges from Public Operated Treatment Work (POTW) operations is the use of chlorine to control bacteria and pathogens . . . the injection of free chlorine can convert HMP fines to forms such as PbCl2 which are highly bioavailable.

The current air and wastewater/water pollution control technologies thus control mass release to the environment which provides for reduction of toxicity from HMP loading, yet fail to modify released HMP fractions to forms which are least bioavailable. Accordingly, there exists a need to augment HMP APC and WSC processes with a HMP Bioavailability Conversion Means (BCM), thus assuring that the anticipated and unanticipated releases of HMP from APC units such as electrostatic precipitators, baghouse filters, cyclones, and WSC units such as sand filtration units, settling ponds, and paper filters are in a form which is least bioavailiable.

### SUMMARY OF THE INVENTION

This invention relates to the method of reducing leachability and bioavailability of HMP matter in air, water and wastewater media prior to the emission of such matter from point sources or non-point sources. The preferred method of reducing bioavailability will be through contacting HMP with at least one heavy metal complex forming agent(s) such that the newly formed heavy metal complex(s) exhibit lower solubility and thus lower bioavailability either under natural or induced leaching and/or under stomach acid digestion in humans and/or animals. The heavy metal complex would be formed prior to emissions of the particulate matter to open environment by contacting the heavy metal particulate with a complexing, agent(s) from heavy metal complex groups including phosphates, phosphonates, polyphosphates, fertilizer phosphates, bone animal and fish phosphates, diatoms, sulfates carbonates, sulfides, silicates, boron, cements, polymers, magnesium and its oxides, calcium and its oxides, iron, aluminum, surfactants, mineral precipitant agents and combinations thereof The complexing method also provides for reducing TCLP (Method 1311), Simulated Precipitant Leaching Procedure (SPLP-Method 1310 which simulates rainwater leaching), Japan DI (uses acid adjusted DI water for 6 hours to simulate rainwater leaching), Swiss sequential DI (uses sequential DI water leaching to simulate rainwater), rainwater and other related leaching of heavy metals from the HMP treated according to the method, and consequently reduces bioavailablity of such particulate matter upon exposure to stomach acids of animals, humans or other biological exposures. The method includes contacting the HMP prior to emission with at least one complexing agent such that particulate matter has reduced heavy metal leaching potential prior to exposure to the environment, particulate deposition area and/or biological community.

This invention has the advantage of reducing the solubility and bioavailability of heavy metals upon first generation of the particulates as a contaminant into the environment. This method also allows the HMP exposed soils/materials to remain below TCLP levels and thus exempt from RCRA hazardous waste regulation. This pre-emission particulate complexing method also assures control of heavy metal leaching and reduction of ecological and human exposure risks by creation of immediate upon-contact water and stomach acid insoluble complex(s). The desired particulate complex produced would be specifically engineered for the source emission character and receptor risks. For example, Pb particulate stack emissions and facility releases from a primary or secondary lead smelter would be complexed prior to release from the facility stacks and emission points to mineral complexes such as Pb5(PO4)3Cl (chloropyromorphite), Pb3(PO4)2 (lead phosphate), lead silicates, corkite, plumbogummite, and other relatively insoluble lead complex minerals which have significantly less mobility and toxicity than the particulate lead form as elemental, lead oxide or lead chloride. The invention provides a means to control metal solubility both under TCLP testing for hazardous waste classification as well as bioavailability in the open environment without significantly modifying the particulate physical character thus providing for continued use of particulate capture devices such as filters which rely upon free flowing nature of emission fines and non-caking on filters.

WSC units which discharge HMP could also be modified to allow for complex agent conversion of bioavailable HMP either during or after chlorination or filtration.

### DETAILED DESCRIPTION OF THE INVENTION

HMP complexing is herein defined as reducing the solubility and thus bioavailability of heavy metal bearing particulates from air, water and wastewater sources. The confirmation of leaching reduction can be determined by performing a suitable leaching test on the particulate as well as physical evaluations of mineral formation under selective electron microscopes (SEM), x-ray diffraction (XRD) and chemical extraction techniques.

Heavy Metal Particulate (HMP) can be in a variety of molecular forms including elemental, anionic or cationic form The most common molecular form of HMP from point-sources such as refuse incinerators, fossil fuel combustors, lead and aluminum smelters, metal casting shops and foundries, shredders, steel mills and non-point sources such as highways, parking, lots, and roofs are as an oxide, sulfate or chloride. Many HMP are in a molecular and physical form designed by the HMP generating facility environmental engineer to achieve large particle capture in APC or WSC filtration units or rapid settling in wastewater tanks. Such engineering does not include methods for HMP uncollected exposure control to receptors such as fish, humans, plant and crops uptake area, and animals Soils and materials subjected to HMP deposition such as residential and crop field soils surrounding smelters and refuse incinerators can for example contain as high as 2500 ppm compositional lead and 50 ppm TCLP leachable lead from long-term constant air stack particulate emission deposition and accumulation.

Leach test conditions, as defined herein, include the conditions to which a material or soil impacted by HMP deposition is subjected during dilute acetic acid leaching (TCLP), buffered citric acid leaching (STLC), distilled water, synthetic rainwater or carbonated water leaching (US SPLP, Japanese and Swiss and SW-924). Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water

Suitable water leach tests include the Japanese leach test which tumbles 50 grams of composited waste sample in 500 ml of water for 6 hours held at pH 5.8 to 6.3, followed by centrifuge and 0 45 micron filtration prior to analyses. Another suitable distilled water CO₂ saturated method is the Swiss protocol using 100 grams of cemented waste at 1 cm³ in two (2) sequential water baths of 2000 ml The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. Leachable heavy metals, contained in the waste, then complex with citrate anions to form lead citrate. The concentration of leached metals are then analyzed by Inductively-Coupled Plasma (ICP) after filtration of a 100 ml aliquot from the tumbler through a 45 micron glass bead filter A WET result of ≧5 ppm lead for example will result in a waste determination as hazardous in California.

According to the methods of the invention, HMP can be complexed by contact with at least one complexing agent at sufficient dosage and duration to allow for complexing of relatively soluble heavy metals to relatively insoluble complex forms. The amount of complexing agent incorporated within and/or upon the HMP will be that which is effective in reducing the leaching of heavy metals from the particulate as needed, for example to a level no more than 5 0 ppm lead, as determined in an EPA TCLP test performed on the particulate or material receiving, the particulate as set forth in the Federal Register, Vol. 55, No 126, pp. 20985-26998 (Jun. 29, 1990), or other leaching test relating to receptor exposures, digestive capacity and or bioaccumulation. Regardless of the receptor, complexing HMP to a less soluble form will directly reduce exposed receptors and environimental health and biological impact risks.

The complexing agent can be incorporated within or applied to the HMP by in-line dry or wet chemical contact prior to or after HMP capture units, bath contact, spray, or other application means Depending on the HMP discharge system such as tall air exhaust stacks and long sewer discharge pipes, application of HMP complexer can easily be added to discarge side of the APC or WSC devices, thus avoiding possible chemical-physical complications with augmentation of the APC and/or WSC unit operation with a HMP complexer As many WSC and APC systems are precisely designed for the process chemistry, post-collection HMP complexing as a polishing unit may be best suited for existing control units It also remains possible that the HMP may be modified during formation of the heavy metal particulate by applying complexing agent(s) to the production process such as within the furnace firebox, within primary shredders, within the wastewater flocculation and coagulation units, and at other locations permitting introduction of complexers to convert particulate metals to non-leachable complex form(s) Given that the particulate surface is the primary exposure area to the environment and that the complex surface will likely reduce or significantly retard diffusion from the particulate core, the stabilization of the HMP surface alone is offered as the most cost effective control which also provides for use of field spray post-stack air pollution control devices that can be applied to existing operations not utilizing heavy metal complexation during production

In one embodiment of the invention, the heavy metal bearing particulate from an air emission point source is contacted with a complexing agent from the phosphate group in-line prior to exhaust of air emissions from the facility stack. The introduction of phosphates into the facility emission stream permits the particulate emissions contact with the introduced PO4 complexing sources and thus converts Pb, Cd, As and Zn fine particulates and associated metal oxides and chlorides to phosphate complexed metals which are substantially less soluble and less bioavailable. The introduction of the phosphate complex with or without additional complex agents depends on the emission heavy metal compositions and can also be selected by the designer depending on desired contact time and observed complex formation conditions such as temperature, mixing energy and retention variations such as contact time on fabric filters prior to automatic cleaning cycles.

The option to utilize various complexing agents and various points of application provides the environmental engineer flexibility in stabilizing agent recipe selection, with a preferred choice responding to the site and use criteria such as TCLP, DI or other biological based toxicity criteria

The use of engineered phosphates such as wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), trisodium phosphate, polyphosphates, tetrapotassium phosphate, dicalcium phosphate, tricalcium phosphate, calcium orthophosphates, and combinations thereof would, as an example, provide various amount of phosphate contact with particulates In certain cases such as use of amber and green acid, such acids embody sulfuric acid, vanadium, iron, aluminum and other complexing agents which could provide for a single-step formation of complex minerals with particulate metals such as lead, cadmium, zinc, copper, arsenic and chromium. The phosphate group chemical size, dose rate, contact duration, and application means could be engineered for each type of particulate and process generating the particulate.

When lead comes into contact with the Pb complexing agent(s), low water soluble compound(s) begin to form, typically a mineral phosphate or precipitate formed through substitution or surface bonding which is less soluble than the lead originally in the particulate matter For example, the mineral apatite lead phosphate Ca₄(Pb)(PO₄)₃ OH, lead phosphate Pb₃(PO₄)₂, lead silicate Pb₂(SlO₃), lead sulfide PbS, chloropyromorphite Pb5(PO)4Cl, corkite and plumbogummite can be formed by adding respective precipitating agents with complexing agents to the particulate. It also remains possible that modifications to temperature and pressure may accelerate of assist formation of lead minerals and complexes, although such methods are not considered optimal for this application given the need to limit cost and provide for optional field based complexing operations that would be complicated by the need for pressure and temperature control devices and vessels Use of complex agents for mineral formation of lead bearing wastes post-generation is taught by U.S. Pat. No 5,722,928 issued to Forrester.

Examples of suitable arsenic, lead, cadmium, chromium, copper and zinc stabilizing agents include, but are not limited to, phosphate fertilizers (e.g., MAP, DAP, SSP, TSP), phosphate rock, pulverized phosphate rock, calcium orthophosphates, monocalcium phosphate, dicalcium phosphate, tricalcium phosphate, trisodium phosphates, phosphate fertilizers, dolomitic limestone, hydrated limestone, calcium oxide (quicklime), calcium carbonates, magnesium oxide, silicates, sodium metasilicates, potassium silicates, natural phosphates and lead mineralizing agents and combinations of the above, phosphoric acids, green phosphoric acid, amber phosphoric acid, black phosphoric acid, merchant grade phosphoric acid, Coproduct solution, hypophosphoric acid, metaphosphoric acid, hexametaphosphate, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of heavy metal complexing agent used, according to the method of invention, depend on various factors including particulate character, desired solubility reduction potential desired complex toxicity, and desired complex formation relating to toxicological and site environmental control objectives. It has been found that an amount of certain complex agents such as triple superphosphate, wet process amber phosphoric acid, and magnesium oxide, equivalent to between about 0.1% and about 15% by weight of particulate emission is sufficient for TCLP complexing of HMP refuse incinerator flyash, electric arc furnace dust, brass foundry flyash, lead smelter flyash, shredder dust, utility stormwater tines. However, the foregoing is not intended to preclude yet higher or lower usage of complex agent or combinations if needed since it has been demonstrated that amounts greater than 15% by weight also work, but are more costly.

The examples below are merely illustrative of this invention and are not intended to limit it thereby in any way

### EXAMPLE 1

In this example, refuse incinerator flyash fines at 1.0 to 50.0 micron containing soluble Pb and Cd were complexed with varying amounts of agents including amber phosphoric acid (WAA), pulverized triple superphosphate (TSP) and pulverized magnesium oxide powder (MGO). Complexed and un-complexed particulate samples were subsequently tested for TCLP and DI leachable Pb and Cd. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution. This test procedure is also referenced in 40 C F R. 260 (Appendix 2) and EPA SW 846, 3^{rd} Edition The retained leachate was digested prior to analysis by ICP.

TABLE 1
REFUSE INCINERATOR FLYASH

| Complexer Dose (%) | Pb TCLP/DI (ppm) | Cd TCLP/DI (ppm) |
|---|---|---|
| 0 | 54.0/5.6 | 1.4/0.05 |
| 5 WAA | 0.05/0.05 | 0.05/0.05 |
| 5 TSP | 0.05/0.05 | 0.65/0.05 |
| 5 MgO | 1.2/0.05 | 0.05/0.05 |

### EXAMPLE 2

In this example, electric arc furnace dust fines at 1.0 to 50.0 micron containing soluble Pb, and Zn were complexed with varying amounts of agents including amber phosphoric acid (WAA), pulverized triple superphosphate. Complexed and un-complexed particulate samples were subsequently tested for TCLP and DI leachable Pb and Zn. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution This test procedure is also referenced in 40 C.F.R. 260 (Appendix 2) and EPA SW 846, 3^{rd} Edition The retained leachate was digested prior to analysis by ICP.

TABLE 2
ELECTRIC ARC FURNACE DUST

| Complexer Dose (%) | Pb TCLP/DI (ppm) | Zn TCLP/DI (ppm) |
|---|---|---|
| 0 | 367/38.5 | 1300/50 |
| 5 WAA | 2.5/0.05 | 16/0.05 |
| 5 TSP | 5.9/0.05 | 58/0.05 |

### EXAMPLE 3

In this example, brass foundry flyash fines at 1.0 to 100.0 micron containing soluble Pb were complexed with varying amounts of agents including amber phosphoric acid (WAA), pulverized triple superphosphate (TSP) and pulverized magnesium oxide powder (MGO) Complexed and un-complexed particulate samples were subsequently tested for TCLP and DI leachable Pb. Particulates were extracted according to TCLP procedure set forth in Federal Register, Vol 55 No 126, pp. 26985-26998 (Jun. 29, 199), which is hereby incorporated by reference, and water extraction by substituting deionized water for the TCLP extraction fluid solution. This test procedure is also referenced in 40 C.F.R. 260 (Appendix 2) and EPA SW 846, 3^{rd} Edition. The retained leachate was digested prior to analysis by ICP.

TABLE 3
BRASS FOUNDRY FLYASH

| Complexer Dose (%) | Pb TCLP/DI (ppm) |
|---|---|
| 0 | 32.0/1.3 |
| 5 WAA | 0.05/0.05 |
| 5 TSP | 0.05/0.05 |
| 5 MgO | 0.05/0.02 |

### EXAMPLE 4

In this example, smelter flyash fines at 1 0 to 50.0 micron containing soluble Pb were complexed with varying amounts of agents including amber phosphoric acid (WAA), and pulverized triple superphosphate (TSP) Complexed and un-complexed particulate samples were subsequently tested for TCLP and DI leachable Pb. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution. This test procedure is also referenced in 40 C F R. 260 (Appendix 2) and EPA SW 846, 3^{rd} Edition. The retained leachate was digested prior to analysis by ICP.

TABLE 4
SMELTER FLYASH

| Complexer Dose (%) | Pb TCLP/DI (ppm) |
|---|---|
| 0 | 683/15.6 |
| 5 WAA | 0.05/0.05 |
| 5 TSP | 0.05/0.05 |

### EXAMPLE 5

In this example, wire shredder dust fines at 1.0 to 50.0 micron containing soluble Pb were complexed with varying amounts of agents including amber phosphoric acid (WAA), pulverized triple superphosphate (TSP) and pulverized magnesium oxide powder (MGO). Complexed and un-complexed particulate samples were subsequently tested for TCLP and DI leachable Pb. Particulates were extracted according to TCLP procedure set forth in Federal Register, Vol. 55, No 126, pp. 26985-26998 (Jun. 29, 199), which is hereby incorporated by reference, and water extraction by substituting deionized water for the TCLP extraction fluid solution This test procedure is also referenced in 40 C.F.R. 260 (Appendix 2) and EPA SW 846, 3^{rd} Edition. The retained leachate was digested prior to analysis by ICP.

TABLE 5
SHREDDER DUST

| Complexer Dose (%) | Pb TCLP/DI (ppm) |
|---|---|
| 0 | 12.0/0.05 |
| 5 WAA | 0.05/0.05 |
| 5 TSP | 0.05/0.05 |
| 5 MgO | 0.5/0.05 |

### EXAMPLE 6

In this example, utility stormwater fines at 1.0 to 250.0 micron containing soluble Pb were complexed with varying, amounts of agents including amber phosphoric acid (WAA), pulverized triple superphosphate (TSP) and pulverized magnesium oxide powder (MGO). Complexed and un-complexed particulate samples were subsequently tested for TCLP and DI leachable Pb and Cd Particulates were extracted according to TCLP procedure set forth in Federal Register, Vol 55, No. 126, pp. 26985-26998 (Jun. 29, 199), which is hereby incorporated by reference and water extraction by substituting deionized water for the TCLP extraction fluid solution This test procedure is also referenced in 40 C.F.R. 260 (Appendix 2) and EPA SW 846, 3^{rd} Edition. The retained leachate was digested prior to analysis by ICP.

TABLE 6
UTILITY MANHOLE STORMWATER FINES

| Complexer Dose (%) | Pb TCLP/DI (ppm) |
|---|---|
| 0 | 14.6/1.6 |
| 5 WAA | 0.05/0.05 |
| 5 TSP | 0.05/0.05 |
| 5 MgO | 0.05/0.05 |

The foregoing results readily established the operability of the present process to complex heavy metals particulate thus reducing leachability and bioavailability. Given the effectiveness of the complexing agents as presented in the Table 1 and 2, it is believed that an amount of the stabilizing agents equivalent to less than 1% by weight of particulate emission should be effective

While this invention has been particularly shown and described with reference to preferred embodiments thereof, it will be understood by those skilled in the art that various changes in form and details may be made therein without departing from the spirit and scope of the invention as defined by the appended claims.

I claim:

1 A method of reducing the solubility and bioavailability of heavy metals within particulate emissions from air, wastewater and water sources, comprising contacting heavy metal particulate with at least one complexing agent in an amount effective in reducing the leaching of heavy metal from particulate and thus reducing particulate bioavailability

2 The method of claim 1, wherein the heavy metal complexing agent is selected from the phosphate croup consisting of water soluble phosphates, water insoluble phosphates, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, monocalcium phosphate, monoammonia phosphate, diammonium phosphate, dicalcium phosphate, tricalcium phosphate, trisodium phosphate salts of phosphoric acid, and combinations thereof

3 The method of claim 2, wherein the salts of phosphoric acid are alkali metal salts

4. The method of claim 2, wherein the phosphate salt is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof

5 The method of claim 2, wherein the phosphate is combined with an additional heavy metal complexing agent including Portland cement, calcium oxide, magnesium oxide, iron, calcium, calcium chloride, potassium chloride, sodium chloride, chlorides, aluminum, sulfates, surfactants, silicates, precipitants, coagulants, reducing agents, oxidizing agents and combinations thereof.

6. The method of claim 1, wherein the complexing agents are selected from the non-phosphate group including polymers, silicates, calcium oxide, quicklime, magnesium oxides, surfactants, calcium chloride, sodium chloride, potassium chloride, vanadium, boron, iron, aluminum, sulfates, reducing agents, oxidizing agents, flocculants, coagulants, precipitants, or combinations thereof.
